(19) United States
(12) Patent Application Publication
(10) Pub. No.: US 2019/0331084 A1
(43) Pub. Date: Oct. 31, 2019

(54) PUMPED STORAGE POWER STATION WITH ULTRA-CAPACITOR ARRAY

(71) Applicant: ELLOMAY CAPITAL LTD., Tel-Aviv (IL)

(72) Inventor: Ran FRIDRICH, Ramat-Gan (IL)

(73) Assignee: ELLOMAY CAPITAL LTD., Tel-Aviv (IL)

(21) Appl. No.: 15/963,102

(22) Filed: Apr. 26, 2018

(51) Int. Cl. F03B 13/06; H02J 7/00; H02J 15/00

(52) U.S. Cl. CPC F03B 13/06; H02J 7/345; H02J 15/003; H02J 7/0013

(57) ABSTRACT

A pumped storage power station includes a connection to an electrical power distribution grid. A pumped-storage hydroelectric system is configured to store energy by pumping a liquid to an upper reservoir, and to enable recovery of the stored energy by enabling the liquid to flow from the upper reservoir to a lower reservoir. A controller is configured to operate a pump of the pumped-storage hydroelectric system to store electrical power from the grid in the pumped-storage hydroelectric system and to charge an array of ultra-capacitors. The controller is further configured to discharge the ultra-capacitor array and to cause release of the liquid from the upper reservoir to recover stored energy as electrical power for input to the grid. The ultra-capacitor array is configured to provide electrical power by discharging until electrical power recovered from the pumped-storage hydroelectric system is suitable for input to the grid.

### FIELD OF THE INVENTION

The present invention relates to power storage. More particularly, the present invention relates to a pumped storage power station with ultra-capacitor array storage.

### BACKGROUND OF THE INVENTION

In many cases, demand for electrical power does not at all times match supply capability. For example, various renewable power sources, such as solar energy, wind power, tidal power, wave power, and other such natural sources of power may be intermittent or subject to variations that may or may not have a predictable pattern. As another example, a fuel-powered electrical power production plant may operate most efficiently when electrical power production is at a certain constant rate. Demand, on the other hand, may depend on various daily, weekly, or other patterns of human activity that may not be coordinated with rates of power production. Thus, there may be periods of excess energy supply, when energy supply exceeds demand, and other periods when demand exceeds supply. In some cases, a plant or facility may prefer to purchase electrical power from an electrical utility during off-peak hours (e.g., nighttime or weekends), when electrical power is sold at a lower rate. On the other hand, the facility's use of electrical power may peak at another time (e.g., during daytime hours on a weekday). Thus, it may be advantageous for such a facility to store purchased electrical power during the off-peak periods for recovery during peak periods.

In many cases, it may be useful to store produced energy during periods when supply exceeds demand, and to recover that stored energy when demand exceeds supply. Various systems have been designed to store surplus produced energy for recovery during periods of excess demand. For example, a system may be based on a reversible chemical reaction as in a storage battery, mechanical energy as in a flywheel, electrostatic energy as in a capacitor, or on another form of reversible process.

In particular, pumped-storage hydroelectricity, based on gravitational potential energy, may be an attractive option. In some cases, pumped-storage hydroelectricity may be more efficient, e.g., with a higher rate of energy recovery (e.g., the ratio of recovered energy to stored energy) than other forms of energy storage. A pumped-storage power station includes two water reservoirs, one of which is significantly higher than the other. One or both of the water reservoirs may be natural (e.g., a lake or sea) or may be man-made. During periods of surplus electrical power production, the electricity is used to pump the water upstream from the lower reservoir to the higher reservoir. Thus, the water gains gravitational potential energy. During periods of excess demand, the water is allowed to flow downstream from the higher reservoir to the lower reservoir via a turbine that is coupled to an electrical generator. Thus, the gravitational potential energy is recovered to produce electrical power.

### SUMMARY OF THE INVENTION

There is thus provided, in accordance with an embodiment of the present invention, a pumped storage power station including: a connection to an electrical power distribution grid; a pumped-storage hydroelectric system that is configured to store energy by pumping a liquid from a lower reservoir to an upper reservoir at an elevation above the elevation of the lower reservoir, and to enable recovery of the stored energy by enabling the liquid to flow from the upper reservoir to the lower reservoir so as to operate a generator (e.g., via a turbine); an ultra-capacitor array of one or a plurality of ultra-capacitors; and a controller configured to operate a pump of the pumped-storage hydroelectric system to store electrical power from the grid as energy in the pumped-storage hydroelectric system and to charge the ultra-capacitor array with electrical power from the grid, and further configured to discharge the ultra-capacitor array and to cause release of the liquid from the upper reservoir to recover the stored energy as electrical power for input to the grid, the ultra-capacitor array configured to provide the electrical power by discharging until electrical power that is recovered from the pumped-storage hydroelectric system is suitable for input to the grid.

Furthermore, in accordance with an embodiment of the present invention, the controller is configured to discharge the ultra-capacitor array concurrently with opening a valve to enable downstream flow of the liquid from the upper reservoir to the lower reservoir to operate the generator.

Furthermore, in accordance with an embodiment of the present invention, the ultra-capacitor array when fully charged is configured to provide electrical power to the grid for at least 40 seconds.

Furthermore, in accordance with an embodiment of the present invention, the controller is configured to concurrently operate the pump to store electrical power in the pumped-storage hydroelectric system and charge the ultra-capacitor array.

Furthermore, in accordance with an embodiment of the present invention, circuitry for storing energy in the ultra-capacitor array includes a rectifier.

Furthermore, in accordance with an embodiment of the present invention, circuitry for recovering energy from the ultra-capacitor array includes an inverter.

There is further provided, in accordance with an embodiment of the present invention, a method for operating a power station that includes a pumped-storage hydroelectric system and an ultra-capacitor array, the method including: storing energy from a grid for distribution of electrical power by, using the electrical power from the grid, operating a pump of the pumped-storage hydroelectric system to a pump a liquid from a lower reservoir of the system to an upper reservoir of the system, the upper reservoir at an elevation that is above the elevation of the lower reservoir, charging one or more ultra-capacitors of the ultra-capacitor array; and recovering stored energy for input as electrical power into the grid by discharging the ultra-capacitor array and by causing release of the liquid from the upper reservoir to operate a generator (e.g., a turbine of the generator), the discharging of the ultra-capacitor array continuing at least until electrical power that is generated by the generator is suitable for input to the grid.

Furthermore, in accordance with an embodiment of the present invention, recovering the stored energy includes discharging the ultra-capacitor array concurrently with opening a valve to enable downstream flow of the liquid from the upper reservoir to the lower reservoir to operate the generator.

Furthermore, in accordance with an embodiment of the present invention, discharging the ultra-capacitor array continues for at least 40 seconds.

Furthermore, in accordance with an embodiment of the present invention, storing the energy includes concurrently operating the pump and charging the ultra-capacitor array.

Furthermore, in accordance with an embodiment of the present invention, charging the ultra-capacitor array includes rectifying an alternating current.

Furthermore, in accordance with an embodiment of the present invention, discharging the ultra-capacitor array includes inverting direct current from the ultra-capacitor array.

### BRIEF DESCRIPTION OF THE DRAWINGS

In order for the present invention to be better understood and for its practical applications to be appreciated, the following Figures are provided and referenced hereafter. It should be noted that the Figures are given as examples only and in no way limit the scope of the invention. Like components are denoted by like reference numerals.

FIG. 1 schematically illustrates a pumped storage power station, in accordance with an embodiment of the present invention.

FIG. 2 is a flowchart depicting a method of operation of a pumped storage power station, in accordance with an embodiment of the present invention.

### DETAILED DESCRIPTION OF THE INVENTION

In the following detailed description, numerous specific details are set forth in order to provide a thorough understanding of the invention. However, it will be understood by those of ordinary skill in the art that the invention may be practiced without these specific details. In other instances, well-known methods, procedures, components, modules, units and/or circuits have not been described in detail so as not to obscure the invention.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium (e.g., a memory) that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently. Unless otherwise indicated, the conjunction “or” as used herein is to be understood as inclusive (any or all of the stated options).

Some embodiments of the invention may include an article such as a computer or processor readable medium, or a computer or processor non-transitory storage medium, such as for example a memory, a disk drive, or a USB flash memory, encoding, including or storing instructions, e.g., computer-executable instructions, which when executed by a processor or controller, carry out methods disclosed herein.

In accordance with an embodiment of the present invention, a pumped storage power station includes an array of ultra-capacitors to store electrical power in addition to pumped hydroelectric storage.

For example, a power generation system or electrical power utility may generate electrical power from one or more renewable or manmade sources. For each type of power source, a power converter may be provided for converting energy from the energy source to electrical power. The energy source may include a renewable source of energy (e.g., solar, wind, geothermal, wave, tidal, hydropower, or another natural energy source), or a fuel-based power generator (e.g., based on combustion of a combustible fuel, on nuclear fission, or other fuel-based energy production). The energy source may be constant (e.g., a continuously operating fuel powered, geothermal, or other type of constant power source) or intermittent (e.g., solar, wind, wave, tidal, or other variable power source).

Energy that is produced by the energy source may be harnessed via an appropriate mechanism to rotate a turbine that is coupled to an electrical generator, or to otherwise (e.g., via photovoltaics, magneto-hydrodynamics, or otherwise) generate electrical power. The generated electrical power may be distributed to end users via an electrical power distribution grid. The electrical power distribution grid may be local (e.g., a single building, plant, campus, or other limited group of end users), regional, or serving a wider area (e.g., national or international).

As another example, an electrical power utility may adjust the cost of electrical power based on actual or predicted demand. For example, the cost per unit of electrical energy may be raised during times of peak demand (e.g., during the course of a typical work day), and may be lowered during off-peak periods (e.g., nighttime hours, weekends, holidays, or other off-peak periods).

The pumped storage power station is configured to store energy when so instructed by a control center, e.g., of the power distribution grid, when such storage is deemed to be advantageous. Similarly, the pumped storage power station is configured to enable recovery of the stored energy when so instructed by the control center.

The pumped storage power station includes at least a pumped-storage hydroelectric system and an ultra-capacitor array.

The pumped-storage hydroelectric system is configured to store energy by raising a liquid, typically water, from a lower reservoir to an upper reservoir that is located at a higher elevation than the lower reservoir. Thus, the quantity of stored energy is in direct proportion to the potential energy of the raised liquid. A pump may be operated by any surplus electrical power to raise the liquid from the lower reservoir to the upper reservoir. When the stored potential energy of the liquid is to be recovered for conversion into electrical power, one or more valves may be opened to enable downstream flow of liquid from the upper reservoir to the lower reservoir. A conduit through which the liquid flows downstream may include one or more turbines, paddlewheels, or other mechanism that may be operated by flowing liquid to rotate the rotor of an electrical generator. In many cases, a generator (e.g., with a turbine) for generating electrical power from the downstream flow may be configured to function in reverse as a motor and pump for raising the liquid from the lower reservoir to the upper reservoir. In this case, the conduit and pump for raising the liquid from the lower reservoir to the upper reservoir may be identical with the conduit and generator through which the liquid flows downstream from the upper reservoir to the lower reservoir to generate electrical power.

Since operation of the system may be expected to involve losses (e.g., due to overcoming resistive forces due to interaction of the fluid with walls of conduits through which the liquid flows, friction between moving parts of the pump and turbine, impedance losses within the electrical circuitry of the pump or generator, evaporation of the liquid from the upper reservoir, or other sources of losses), the recoverable stored energy is typically less than the energy that has been used to pump a certain quantity of liquid.

The pumped storage power station is also configured to store surplus produced energy in an ultra-capacitor array that includes one or more ultra-capacitors.

As used herein, an ultra-capacitor refers to a high-capacity capacitor with capacitance values much higher than other capacitors, but with lower voltage limits, e.g., as are available from Maxwell Technologies Inc. or from Skeleton Technologies. An ultra-capacitor typically stores 10 to 100 times more energy per unit volume or mass than typical electrolytic capacitors or rechargeable batteries (e.g., with ultra-capacitor specific energy greater than 4 watt-hours per kilogram, in some cases greater than 7 watt-hours per kilogram). Furthermore, an ultra-capacitor may accept and deliver charge much faster, tolerate many more charge and discharge cycles (e.g., capable of more than a million charge-discharge cycles), and have a much lower internal resistance (e.g., having equivalent series resistance less than 1 mΩ, in some cases as low as 0.12 mΩ) a typical rechargeable battery. For example, a typical ultra-capacitor may have a capacitance in the range of about 500 F to 4000 F, for a rated voltage between 2.7 V and 3 V.

For example, alternating current from the power generator may be rectified to charge the ultra-capacitor array. The ultra-capacitor array may be charged concurrently with storing energy in the pumped-storage hydroelectric system. For example, control or other circuitry may be configured to direct a portion of the current to the ultra-capacitor array, and the remainder of the current to the pumped-storage hydroelectric system. Alternatively or in addition, the ultra-capacitor array may be fully charged (e.g., with a charge that is close to the maximum charge of the ultra-capacitor array, e.g., as determined by a breakdown voltage of the ultra-capacitors, or another predetermined charge) before storing the remaining surplus energy in the pumped-storage hydroelectric system, or after storing a pre-determined quantity of energy in the pumped-storage hydroelectric system. When energy is recovered from the ultra-capacitor array, the produced direct current may be converted by an inverter to alternating current that is suitable for supplying to the power distribution grid.

A pumped storage power station that includes ultra-capacitor energy storage together with pumped hydroelectric storage may be advantageous over a pumped-storage hydroelectric system that lacks an ultra-capacitor array. For example, a considerable time may lapse between the instruction of a control center to recover stored energy from a pumped-storage hydroelectric system and full generation of electrical power for input into the power distribution grid. Contributions to this delay time may include acceleration time for the water flow, inertia and friction in moving parts of the system, synchronization of the recovery generator with the power distribution grid, or other sources of delay. A typical pumped-storage hydroelectric system, depending on the configuration of the system and the state of the system prior to energy recovery, may require between 40 seconds and 500 seconds to reach its full generating capacity. During this time, devices that are powered by the distribution grid that is associated with the pumped-storage hydroelectric system may cease operation.

On the other hand, recovering energy from an ultra-capacitor array may be instantaneous (e.g., in that any delay does not significantly or noticeably affect operation of powered devices). For example, recovering stored energy from the ultra-capacitor array may require only operation of a switch and related electronics (e.g., inverters, filters, amplifiers, or other electronics). Thus, full energy recovery from the ultra-capacitor array may require no more than a hundredth of a second (e.g., between 5 milliseconds and 10 milliseconds).

A control center (e.g., of an electrical power utility) that operates the pumped storage power station may be configured to sense an urgent condition of excess demand. For example, such excess demand may result from a failure or disconnection from the power distribution grid of a power source. When a condition of excess demand is sensed, the control center may instruct to begin energy recovery from the pumped storage power station. A controller of the pumped storage power station may then recover stored energy from the pumped-storage hydroelectric system. Concurrently, energy may be recovered from the ultra-capacitor system. The ultra-capacitor system may provide sufficient power to satisfy the excess demand during the period (which may be 40 seconds or more) during which energy recovery from the pumped-storage hydroelectric system is reaching its full capacity and is not yet suitable for input to the distribution grid. When the energy from the pumped-storage hydroelectric system reaches full requested capacity and is suitable for input to the distribution grid, recovery from the ultra-capacitor system may be stopped. Thus, a pumped storage power station that includes both a pumped-storage hydroelectric system and an ultra-capacitor system for recovering power may be able to operate continuously with no noticeable gaps in service.

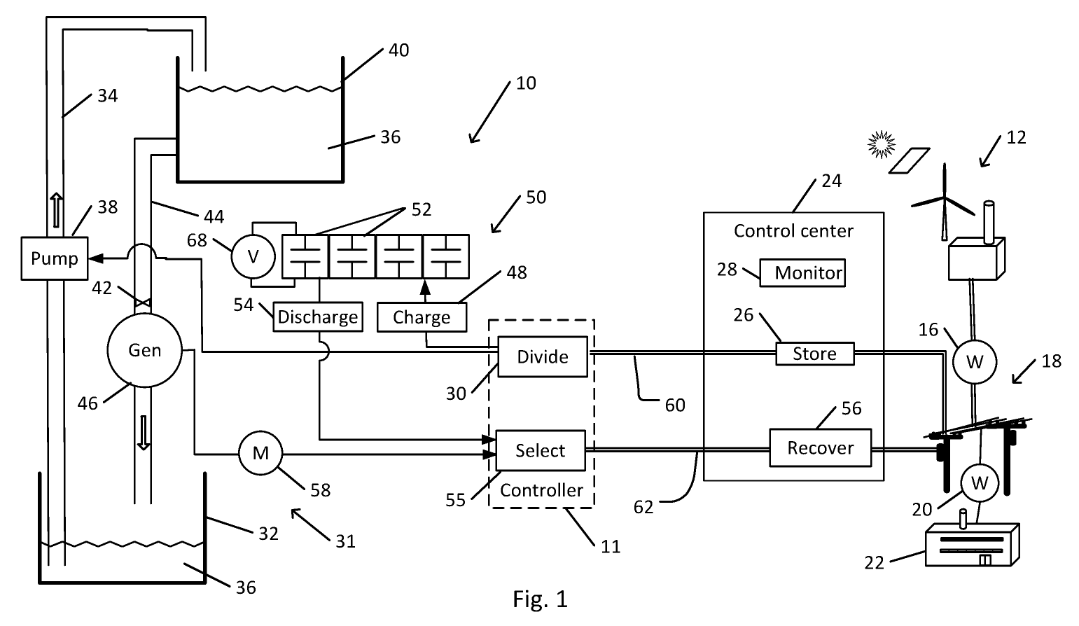

FIG. 1 schematically illustrates a pumped storage power station, in accordance with an embodiment of the present invention.

Pumped storage power station 10 is configured to store surplus electrical power from electrical power sources 12 from power distribution grid 18. Pumped storage power station 10 may be connected to power distribution grid 18, e.g., via one or more power storage lines 60.

For example, power distribution grid 18 may receive electric power that is generated by one or more electrical power sources 12. Electrical power supply to power distribution grid 18 from electrical power sources 12 may be monitored by a power meter 16 (e.g., a wattmeter) or other device that measures electrical power that is supplied to power distribution grid 18 by electrical power sources 12.

Power distribution grid 18 may connect to one or more end users 22. Typically, each end user 22 (e.g., a residence, office, plant, building, or other facility) is connected to power distribution grid 18 via a power usage meter 20.

Pumped storage power station 10 is configured to store surplus electrical power that is produced by electrical power sources 12 in pumped-storage hydroelectric system 31 and ultra-capacitor array 50. For example, pumped storage power station 10 may be connected to power distribution grid 18 (e.g., via power storage line 60 and via recovered power line 62). Control center 24 (e.g., of a utility or other operator of power distribution grid 18) may be configured to enable surplus power from electrical power sources 12 to be stored by pumped storage power station 10. Controller 11 of pumped storage power station 10 may cause the surplus power to be stored in pumped-storage hydroelectric system 31 and in ultra-capacitor array 50. Similarly, control center 24 may be configured to cause the energy stored by pumped storage power station 10 to be recovered for supplying the recovered energy to power distribution grid 18 via recovered power line 62. Controller 11 of pumped storage power station 10 may cause the stored energy to be recovered from one or both of pumped-storage hydroelectric system 31 and ultra-capacitor array 50.

Control center 24 may include one or more modules (e.g., automatic or human-operated capabilities) for controlling operation of pumped storage power station 10. For example, control center 24 may include a single device (e.g., with components housed in a single housing or room) having one or more different functionalities, or may consist of two or more separate intercommunicating devices (which may be housed remotely from one another). For example, monitoring module 28 of control center 24 may evaluate one or more conditions (e.g., excess supply or demand for electrical power, cost of supplied electrical power, or other conditions) related to power distribution grid 18. Energy storage module 26 may be configured to cause controller 11 of pumped storage power station 10 to cause electrical power to be stored in one or both of pumped-storage hydroelectric system 31 and ultra-capacitor array 50. Energy recovery module 56 of control center 24 may be configured to cause controller 11 of pumped storage power station 10 to cause stored energy to be recovered from pumped storage power station 10 for transmission to power distribution grid 18. In some cases, control center 24 may cause energy to be stored to, or recovered from, one or more additional energy storage systems or facilities.

Electrical power that is diverted to power storage line 60 by energy storage module 26 may be directed by power division module 30, of controller 11 of pumped storage power station 10, to one or both of pumped-storage hydroelectric system 31 and ultra-capacitor array 50.

For example, power division module 30 may enable charging of ultra-capacitor array 50 in parallel with energy storage by pumped-storage hydroelectric system 31. In this case, charging of ultra-capacitor array 50 may continue until ultra-capacitor array 50 is charged to an equilibrium voltage, e.g., with the voltage in power storage line 60 (e.g., after rectification). After ultra-capacitor array 50 is charged to the equilibrium voltage, energy may continue to be stored by pumped-storage hydroelectric system 31.

Alternatively or in addition, power division module 30 may be configured to initially direct all, or a predetermined fraction, of the electrical power that is diverted from power storage line 60 by energy storage module 26 to ultra-capacitor array 50. Power division module 30 may then be further configured to gradually, stepwise, or abruptly increase the fraction of electrical power that is directed to pumped-storage hydroelectric system 31 in accordance with a monitored voltage of ultra-capacitor array 50, e.g., as measured by ultra-capacitor array voltmeter 68. For example, when the voltage of ultra-capacitor array 50 is measured to be a predetermined voltage, all of the diverted power may be directed to pumped-storage hydroelectric system 31.

Alternatively or in addition, power division module 30 may be configured to otherwise control direction of the diverted electrical power to one or both of pumped-storage hydroelectric system 31 and ultra-capacitor array 50 in accordance with one or more other algorithms, patterns, or schemes.

Ultra-capacitor array 50 includes an array of one or more ultra-capacitors 52. For example, a plurality of ultra-capacitors 52 may be connected in parallel to form an ultra-capacitor array 50 with a greater capacitance than (and approximately same rated voltage as) an individual ultra-capacitor 52, or in series to form an ultra-capacitor array 50 with a greater rated voltage (and lower capacitance) than an individual ultra-capacitor 52. Electrical power from power storage line 60 may be directed by power division module 30 via charging circuitry 48 to charge ultra-capacitors 52. Typically, the electrical current in power storage line 60 is alternating current. Therefore, charging circuitry 48 may include a rectifier to convert the alternating current to direct current (e.g., rectified current) in order to charge ultra-capacitors 52. In some cases, charging circuitry 48 may include additional filtering or other circuitry. In some cases, one or both of ultra-capacitor array 50 and pumped-storage hydroelectric system 31 may be located in an underground cavern or other protected location.

Electrical power that is directed to pumped-storage hydroelectric system 31 by power division module 30 may be utilized to operate pump 38. Pump 38 is configured to pump energy storage liquid 36 (e.g., fresh water or sea water) from a lower reservoir 32 via upstream flow conduit 34 to upper reservoir 40 that is at an elevation that is above the elevation of lower reservoir 32. Thus, the electrical power raises the gravitational potential energy of the upstream pumped energy storage liquid 36 (by a quantity of energy equal to the product of the weight of the raised amount of energy storage liquid 36 multiplied by the height through which energy storage liquid 36 is raised).

For example, upstream flow conduit 34 may include a pipe or channel through which energy storage liquid 36 may flow upstream when pumped by pump 38. Alternatively or in addition, other mechanisms may be operated to raise energy storage liquid 36 from lower reservoir 32 to upper reservoir 40. For example, a mechanism for raising energy storage liquid 36 may include a reversible Francis pump/turbine, an Archimedes' screw mechanism, a bucket elevator mechanism, or another mechanism suitable for raising energy storage liquid 36 from lower reservoir 32 to upper reservoir 40.

One or both of lower reservoir 32 and upper reservoir 40 may be natural or manmade bodies of water or depressions. One or both of lower reservoir 32 and upper reservoir 40 may include two or more separate reservoirs or bodies of water. A valve 42 (e.g., spherical valve or other mechanism) of generator 46 may be closed to retain energy storage liquid 36 within upper reservoir 40.

Electrical power may be selectively recovered from one or both of pumped-storage hydroelectric system 31 and ultra-capacitor array 50 as controlled by power recovery selection module 55 of controller 11 of pumped storage power station 10.

Power recovery selection module 55 may be configured to concurrently recover energy from ultra-capacitor array 50 and from pumped-storage hydroelectric system 31. In some cases, power recovery selection module 55, or another component of pumped storage power station 10, may include one or more transformers or other circuitry (e.g., frequency regulation circuitry, phase regulation circuitry, or other circuitry) for converting electrical power that is recovered from ultra-capacitor array 50 or from pumped-storage hydroelectric system 31 to electrical power that is suitable for input into power distribution grid 18.

For example, ultra-capacitors 52 of ultra-capacitor array 50 may be discharged via discharging circuitry 54 to provide electrical power to power distribution grid 18 via recovered power line 62. For example, discharging circuitry 54 may include an inverter or other circuitry for converting direct current that is discharged from ultra-capacitors 52 to alternating current suitable for distribution by power distribution grid 18 and use by end users 22. Discharging circuitry 54 may include filtering circuitry, amplifiers, or other components or circuitry in order to convert the electrical power that is recovered from ultra-capacitor array 50 to current that is suitable for power distribution grid 18.

Concurrently with recovering stored energy from ultra-capacitor array 50, power recovery selection module 55 may begin energy recovery from pumped-storage hydroelectric system 31. For example, power recovery selection module 55 may cause valves 42 on hydroelectric generator 46 (e.g., at the entrance to a turbine of hydroelectric generator 46) to open. When valve 42 is opened, gravity may cause energy storage liquid 36 to flow downstream via downstream flow conduit 44 and hydroelectric generator 46 to lower reservoir 32. For example, the downstream flow of energy storage liquid 36 through downstream flow conduit 44 (e.g., a channel, pipe, or other form of conduit) may rotate a mechanism (e.g., turbine, waterwheel, or other mechanism) of hydroelectric generator 46 to cause hydroelectric generator 46 to generate electrical power.

In some cases, downstream flow conduit 44 may be identical to upstream flow conduit 34. In some such cases, hydroelectric generator 46 may be identical with pump 38. For example, components of hydroelectric generator 46 may be configured to operate in a reverse mode (e.g., with externally applied electrical power, e.g., via energy storage module 26, causing a turbine of hydroelectric generator 46 to rotate in a reverse direction to impel energy storage liquid 36 to flow upstream, or otherwise operate in a reverse mode) to function as pump 38.

Electrical power generation by hydroelectric generator 46 of pumped-storage hydroelectric system 31 may be monitored, e.g., by one or more hydroelectric power sensors 58. For example, hydroelectric power sensors 58 may be configured to monitor one or more of voltage, current, power, frequency, phase, or other property of the hydroelectric power that is generated by hydroelectric generator 46. Depending on the configuration of pumped-storage hydroelectric system 31 (e.g., locations of lower reservoir 32 and upper reservoir 40, type of hydroelectric generator 46, or other details of the configuration), a startup condition or mode of operation of pumped-storage hydroelectric system 31 prior to energy recovery, or other conditions, a hydroelectric recovery time may elapse between beginning of energy recovery via power recovery selection module 55 and full electrical power generation by hydroelectric generator 46. Startup conditions and modes of operation may include, for example, storing energy by operation of pump 38, idle with no upstream or downstream flow of energy storage liquid 36, in synchronous condenser mode where a turbine of hydroelectric generator 46 is emptied of liquid but is being rotated by a motor (e.g., for the purpose of stabilizing frequency or other conditions in power distribution grid 18), or in another startup condition. For example, hydroelectric recovery time may include time to open valve 42, for the downstream flow of energy storage liquid 36 through downstream flow conduit 44 to reach its full speed, for hydroelectric generator 46 to reach full speed, for synchronizing the electrical power generated by hydroelectric generator 46 with the frequency and phase requirements of power distribution grid 18, or other sources of delay. Interruption of full supply of electrical power during this hydroelectric recovery time (e.g., between 40 seconds and 500 seconds) may be disruptive to at least some end users 22.

On the other hand, discharging circuitry 54 may be configured to produce usable electrical power within an ultra-capacitor recovery time of between 5 milliseconds and 10 milliseconds from energy that is recovered from ultra-capacitor array 50. This ultra-capacitor recovery time may be sufficiently short so as not to be perceptible or disruptive to end users 22. Therefore, electrical power may be provided from ultra-capacitor array 50 in the event that energy recovery is needed, e.g., in the case of an abrupt interruption of electrical power from electrical power sources 12. The storage capacity of ultra-capacitor array 50 may be configured to be sufficient so as to continue to provide electrical power until the hydroelectric recovery time has elapsed and hydroelectric generator 46 is generating electrical power that is suitable for input into power distribution grid 18.

For example, discharging circuitry 54 may be connected to a bus bar or other output circuitry of hydroelectric generator 46. In some cases, power recovery selection module 55 may be configured to continue to recover energy from ultra-capacitor array 50 until energy output from hydroelectric generator 46 (e.g., as sensed by hydroelectric power sensors 58) is suitable for input into power distribution grid 18. At that point, energy recovery from ultra-capacitor array 50 may be stopped (e.g., by opening a switch or otherwise stopping operation of discharging circuitry 54. Alternatively or in addition, ultra-capacitor array 50 may be completely discharged. For example, the capacity of ultra-capacitor array 50 may be configured such that the period of time during which electrical power may be recovered from ultra-capacitor array 50 is substantially equal to (or slightly longer than) the hydroelectric recovery time.

In some cases, ultra-capacitor array 50 may include a plurality of subarrays of ultra-capacitors 52. In this case, power recovery selection module 55 or discharging circuitry 54 may be configured to sequentially discharge each ultra-capacitor subarray (e.g., when a previously discharged ultra-capacitor subarray is fully discharged or is about to be fully discharged).

Pumped storage power station 10 may be operated in accordance with an operation method.

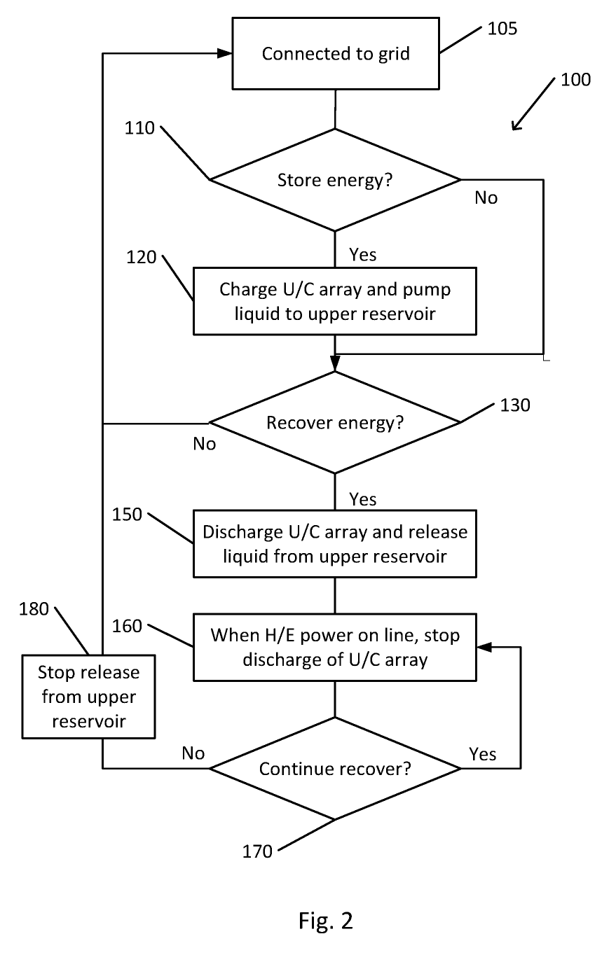

FIG. 2 is a flowchart depicting a method of operation of a pumped storage power station, in accordance with an embodiment of the present invention.

It should be understood with respect to any flowchart referenced herein that the division of the illustrated method into discrete operations represented by blocks of the flowchart has been selected for convenience and clarity only. Alternative division of the illustrated method into discrete operations is possible with equivalent results. Such alternative division of the illustrated method into discrete operations should be understood as representing other embodiments of the illustrated method.

Similarly, it should be understood that, unless indicated otherwise, the illustrated order of execution of the operations represented by blocks of any flowchart referenced herein has been selected for convenience and clarity only. Operations of the illustrated method may be executed in an alternative order, or concurrently, with equivalent results. Such reordering of operations of the illustrated method should be understood as representing other embodiments of the illustrated method.

Pumped power station operation method 100 may be executed by a controller 11 of pumped storage power station 10, e.g., by one or more of power division module 30, power recovery selection module 55, or another component of controller 11 of pumped storage power station 10. In some cases, pumped power station operation method 100 may be executed continuously. In some cases, pumped power station operation method 100 may be executed in response to a command or other action by an operator of pumped storage power station 10 (or of control center 24) or in response to one or more predetermined events or sensed conditions.

Pumped power station operation method 100 may be executed when pumped storage power station 10 is connected to power distribution grid 18 (block 105). During this time, production from electrical power sources 12 and demand by end users 22 via power distribution grid 18 may be monitored.

At some times, diversion of produced electrical power for storage as stored energy may be indicated, e.g., by a human operator or automatic system of control center 24 (block 110). For example, such storage may be indicated when supply exceeds demand, when a price of supplied electrical power is low, during routine operation, or in response to operation of a control by an operator of pumped storage power station 10.

When storage is indicated, some or all of the electrical power that is produced by electrical power sources 12 may be stored at least as electrostatic energy in ultra-capacitor array 50 and as gravitational potential energy by pumped-storage hydroelectric system 31 (block 120). Energy may be stored in ultra-capacitor array 50 and pumped-storage hydroelectric system 31 concurrently, sequentially, or in another order. Energy may additionally be stored in one or more other energy storage devices or systems.

At some times, recovery of stored energy for generation of electrical power for input into power distribution grid 18 may be indicated, e.g., by a human operator or automatic system of control center 24 (block 130). For example, recovery of stored energy may be indicated when the electrical power supply from electrical power sources 12 is interrupted, when demand otherwise exceeds supply, when a price of supplied electrical power is high, or in response to operation of a control by an operator of pumped storage power station 10. Prior to recovery of the stored energy, pumped storage power station 10 may have been idle, may have been storing electrical power, or may have been in another state.

When stored energy is to be recovered, some or all ultra-capacitors 52 of ultra-capacitor (U/C) array 50 may be discharged, and energy storage liquid 36 may be released from upper reservoir 40 of pumped-storage hydroelectric system 31 (block 150). Since stored energy from ultra-capacitor array 50 may be converted to usable electrical power within 10 milliseconds (e.g., after an ultra-capacitor recovery time of between 5 milliseconds and 10 milliseconds), whereas pumped-storage hydroelectric system 31 may require over a minute to produce usable electrical power, at first, e.g., during the hydroelectric recovery time, only electrical power that is recovered from ultra-capacitor array 50 is input to power distribution grid 18.

When pumped-storage hydroelectric (H/E) system 31 is on line such that recovered electrical power from pumped-storage hydroelectric system 31 is suitable for input into power distribution grid 18 (e.g., at the end of hydroelectric recovery time), discharging of ultra-capacitor array 50 may be stopped (block 160). For example, an action (e.g., opening a switch) may be executed to stop the discharge, ultra-capacitor array 50 may be configured to be completely discharged at the end of the hydroelectric recovery time, or discharging may be otherwise stopped. At this point, pumped-storage hydroelectric system 31 may be the sole source of recovered electrical power that is being provided to power distribution grid 18.

The recovery of power from pumped-storage hydroelectric system 31 (continuation of the operations of block 160) may continue as long as such recovery is indicated or as long as a sufficient quantity of energy storage liquid 36 remains in upper reservoir 40 (block 170). When recovery is no longer to be continued, e.g., as indicated by a human operator or automatic system of control center 24, valve 42 may be closed to stop the release of energy storage liquid from upper reservoir 40 (block 180), and the connection to power distribution grid 18 from electrical power sources 12 may continue (block 105).

Different embodiments are disclosed herein. Features of certain embodiments may be combined with features of other embodiments; thus, certain embodiments may be combinations of features of multiple embodiments. The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

1. A pumped storage power station comprising:
a connection to an electrical power distribution grid;
a pumped-storage hydroelectric system that is configured to store energy by pumping a liquid from a lower reservoir to an upper reservoir at an elevation above the elevation of the lower reservoir, and to enable recovery of the stored energy by enabling the liquid to flow from the upper reservoir to the lower reservoir so as to operate a generator;
an ultra-capacitor array of one or a plurality of ultra-capacitors; and
a controller configured to operate a pump of the pumped-storage hydroelectric system to store electrical power from the grid as energy in the pumped-storage hydroelectric system and to charge the ultra-capacitor array with electrical power from the grid, and further configured, when there is a condition of excess power demand, to concurrently recover energy from the pumped-storage hydroelectric system and from the ultra-capacitor array to allow the pumped storage power station to operate continuously,
wherein the ultra-capacitor array is configured to provide electrical power by discharging during a recovery time of the pumped-storage hydroelectric system until electrical power is recovered from the pumped-storage hydroelectric system is suitable for input to the grid.

2. The power station of claim 1, wherein the controller is configured to discharge the ultra-capacitor array concurrently with opening a valve to enable downstream flow of the liquid from the upper reservoir to the lower reservoir to operate the generator.

3. The power station of claim 1, wherein the ultra-capacitor array when fully charged is configured to provide electrical power to the grid for at least 40 seconds.

4. The power station of claim 1, wherein the controller is configured to concurrently operate the pump to store electrical power in the pumped-storage hydroelectric system and charge the ultra-capacitor array.

5. The power station of claim 1, wherein circuitry for storing energy in the ultra-capacitor array includes a rectifier.

6. The power station of claim 1, wherein circuitry for recovering energy from the ultra-capacitor array includes an inverter.

7. A method for operating a power station that includes a pumped-storage hydroelectric system and an ultra-capacitor array, the method comprising:
storing energy from a grid for distribution of electrical power by, using the electrical power from the grid, operating a pump of the pumped-storage hydroelectric system to a pump a liquid from a lower reservoir of the system to an upper reservoir of the system, the upper reservoir at an elevation that is above the elevation of the lower reservoir, charging one or more ultra-capacitors of the ultra-capacitor array; and
when there is a condition of excess power demand, concurrently recovering stored energy for input as electrical power into the grid by discharging the ultra-capacitor array and by causing release of the liquid from the upper reservoir to operate a generator to allow the power station to operate continuously, wherein the discharging of the ultra-capacitor array provides electrical power during a recovery time of the pumped-storage hydroelectric system until electrical power generated by the generator is suitable for input to the grid.

8. The method of claim 7, wherein recovering the stored energy comprises discharging the ultra-capacitor array concurrently with opening a valve to enable downstream flow of the liquid from the upper reservoir to the lower reservoir to operate the generator.

9. The method of claim 7, wherein discharging the ultra-capacitor array continues for at least 40 seconds.

10. The method of claim 7, wherein storing the energy comprises concurrently operating the pump and charging the ultra-capacitor array.

11. The method of claim 7, wherein charging the ultra-capacitor array comprises rectifying an alternating current.

12. The method of claim 7, wherein discharging the ultra-capacitor array comprises inverting direct current from the ultra-capacitor array.

13. The method of claim 7, wherein discharging the ultra-capacitor array comprises providing electrical power to the grid within a recovery time of between 5 milliseconds and 10 milliseconds.

14. The power station of claim 1, wherein the ultra-capacitor array is configured to provide electrical power to the grid within a recovery time of between 5 milliseconds and 10 milliseconds.
